(19) United States
(12) Patent Application Publication
(10) Pub. No.: US 2019/0294920 A1
(43) Pub. Date: Sep. 26, 2019

(54) ACTIVATION BASED FEATURE IDENTIFICATION

(71) Applicant: Maana, Inc, Palo Alto, CA (US)

(72) Inventors: Balasubramanian Kandaswamy, Redmond, WA (US); Alexander Hussam Elkholy, Seattle, WA (US); Steven Matt Gustafson, Sammanish, WA (US)

(21) Appl. No.: 15/934,825

(22) Filed: Mar. 23, 2018

(51) Int. Cl. G06K 9/62; G06F 15/18; G06N 5/00

(52) U.S. Cl. CPC G06K 9/6228; G06N 5/003; G06F 15/18; G06K 9/6256

(57) ABSTRACT

Embodiments are directed towards managing data. A data engine provides a data model that may include a plurality of concepts and a plurality of relations between the concepts. The data engine associates a propagation weight with each relation based on characteristics of the concepts. A feature engine associates an initial impetus value with a pivot concept. The feature engine employs the pivot concept as a start point to recursively traverse the data model. The feature engine allocates a portion of the impetus value to concepts that may be on a direct path of the traversal based on the propagation weight associated with each relation of the concepts. The feature engine may identify feature concepts based on a value of a portion of the impetus value that exceeds a threshold.

### TECHNICAL FIELD

This invention relates generally to information organization and data modeling and more particularly, to identifying features from a data model.

### BACKGROUND

Organizations are generating and collecting an ever increasing amount of data, and are applying machine learning techniques to recognize patterns, divide inputs into classes, identify similarities between inputs, and perform other machine learning tasks. Many of these techniques utilize features—individual measurable properties or characteristics of a phenomenon being observed that are considered relevant inputs to a machine learning algorithm. Identifying an effective set of features continues to be a major topic of research in the machine learning field. Accordingly, it may be difficult to discover relevant features usable by machine learning algorithms. Thus, it is with respect to these considerations and others that the invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 shows a schematic embodiment of a client computer;

FIG. 3 illustrates a schematic embodiment of a network computer;

FIG. 4 shows a data model in accordance with one or more of the various embodiments;

FIG. 5 shows a data model with propagation weights in accordance with one or more of the various embodiments;

FIG. 6 shows a data model with an impetus value at a pivot concept that has spread to adjacent concepts, in accordance with one or more of the various embodiments;

FIG. 7 illustrates a flowchart for a process for activation based feature identification in a data model, in accordance with one or more of the various embodiments;

FIG. 8 illustrates a flowchart for a setup process for assigning propagation weights to relations in a data model, in accordance with one or more of the various embodiments;

FIG. 9 illustrates a flowchart for a process for optional user training using a similarity model in accordance with one or more of the various embodiments;

FIG. 10 illustrates a flowchart for an optional process for passive learning based on joint activation statistics, in accordance with one or more of the various embodiments; and

FIG. 11 illustrates a flowchart for utilizing propagation weights to perform feature concept identification.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. Also, throughout the specification and the claims, the use of “when” and “responsive to” do not imply that associated resultant actions are required to occur immediately or within a particular time period. Instead they are used herein to indicate actions that may occur or be performed in response to one or more conditions being met, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, Python, JavaScript, Ruby, VBScript, Microsoft .NET™ languages such as C#, and/or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein, the terms “raw data set,” or “data set” refer to data sets provided by an organization that may represent the items to be included in a system model. In some embodiments raw data may be provided in various formats. In simple cases, raw data may be provided in spreadsheets, databases, csv files, or the like. In other cases, raw data may be provided using structured XML files, tabular formats, JSON files, model will information from one or more other system models, or the like. In one or more of the various embodiments, raw data in this context may be the product one or more preprocessing operations. For example, one or more pre-processing operations may be executed on information, such as, log files, data dumps, event logs, database dumps, unstructured data, structured data, or the like, or combination thereof. In some cases, the pre-processing may include data cleansing, filtering, or the like. The pre-processing operations, if any, may occur before the information may be considered to be raw data. The particular pre-processing operations may be specialized based on the source, context, format, veracity of the information, access opportunities, or the like. In most cases, raw data may be arranged such that it may be logically viewed as comprising one or more objects, tables, having one or more identifiable fields and/or columns, or the like.

As used herein, the term “data object” refers to an object that models various characteristics of a raw objects or concepts. Data objects may include one or more data object fields that include one or more attributes (e.g., data field attributes) that represent features or characteristics of their corresponding data object fields.

As used herein, the term “feature” refers to an attribute of a data object that may be selected for use as input to a machine learning process. For example, data classifiers may be trained by a machine learning system to identify data objects that have certain features.

As used herein, the term “domain graph” refers to an interconnected set of concept nodes, where each connection between concepts is referred to as a relation. Domain graphs may be used to formalize domain knowledge, as generated by one or more subject matter experts.

As used herein, the term “data model” refers to an interconnected set of concept nodes, typically derived from a domain graph. Each concept in a data model may be represented by a node or vertex in the data model.

As used herein, the term “domain” refers to a field or subject. For example, a computational knowledge graph may include concepts and relations from a human resources domain, including employees, contractors, building resources, or the like.

As used herein, the term “ground concept” refers to a description of a type of data represented by a node in a computational knowledge graph. In one embodiment, for a human resources domain, employees and date of hire are both ground concepts.

As used herein, the term “derived concept”, also referred to as an “inferred concept”, refers to a concept node in a computational knowledge graph that includes a rule based on two or more ground concepts.

As used herein, the term “pivot concept”, refers to a concept in a data model that has been selected to receive an impetus value. Pivot concepts selected based on user inputs, queries, search contexts, or the like, and may vary depending on the purpose of the machine learning models that are being trained.

As used herein, the term “feature concept”, refers to a concept in a data model that has been identified as being an important feature for training a machine learning model.

As used herein, the term “impetus value”, refers to a value that may be provided to evaluate concepts in a data model to identify feature concepts. An impetus values may be assigned to a pivot concept in a data model for propagation via relationships to other concepts in the same data model.

The following briefly describes the various embodiments to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards managing data. In one or more of the various embodiments, a data engine may be instantiated to perform various actions, as described below.

In one or more of the various embodiments, the data engine may provide a data model that may include a plurality of concepts and a plurality of relations between the concepts, such that each concept may be a node in the data model and each relation may be an edge in the data model.

In one or more of the various embodiments, the data engine may associate a propagation weight with each relation based on one or more characteristics of the plurality of concepts, such that the propagation weight may be based on one or more heuristics that may be determined prior to training of a machine learning model. In one or more of the various embodiments, associating the propagation weight with each relation, may include basing the propagation weight on one or more filter metrics for unsupervised feature extraction. Also, in one or more of the various embodiments, associating the propagation weight with each relation may include basing the propagation weight on one or more of a laplacian score or a mutual information gain score that is associated with two or more concepts.

In one or more of the various embodiments, a feature engine may be instantiated to perform various actions, as described below.

In one or more of the various embodiments, the feature engine may associate an initial impetus value with a pivot concept such that a query may be employed to select one of the plurality of concepts as the pivot concept.

In one or more of the various embodiments, the feature engine may employ the pivot concept as a start point to recursively traverse the data model.

In one or more of the various embodiments, the feature engine may allocate a portion of the impetus value to one or more concepts that may be on a direct path of the traversal based on the propagation weight associated with each relation of the one or more concepts. In one or more of the various embodiments, allocating the portion of the impetus value to the one or more concepts, may include omitting one or more concepts from the allocation if the allocated portion of the impetus value is less than the threshold value.

In one or more of the various embodiments, the feature engine may identify one or more of the plurality concepts as a feature concept based on a value of a portion of the impetus value that exceeds a threshold.

In one or more of the various embodiments, the feature engine may increase the portion of the impetus value associated with one or more of the plurality of concepts based on a number of times the one or more concepts were previously identified as the feature concept.

In one or more of the various embodiments, the feature engine may update one or more propagation weights based on joint usage statistics captured from a user interacting with the data model such that one or more propagation weights in the data model may be increased if two or more concepts having a relation are interacted with by the user.

In one or more of the various embodiments, a machine learning engine may be instantiated to employ the one or more feature concepts to train the machine learning model such that the use of the one or more feature concepts reduces one or more computing resources required to train the machine learning model.

### Illustrated Operating Environment

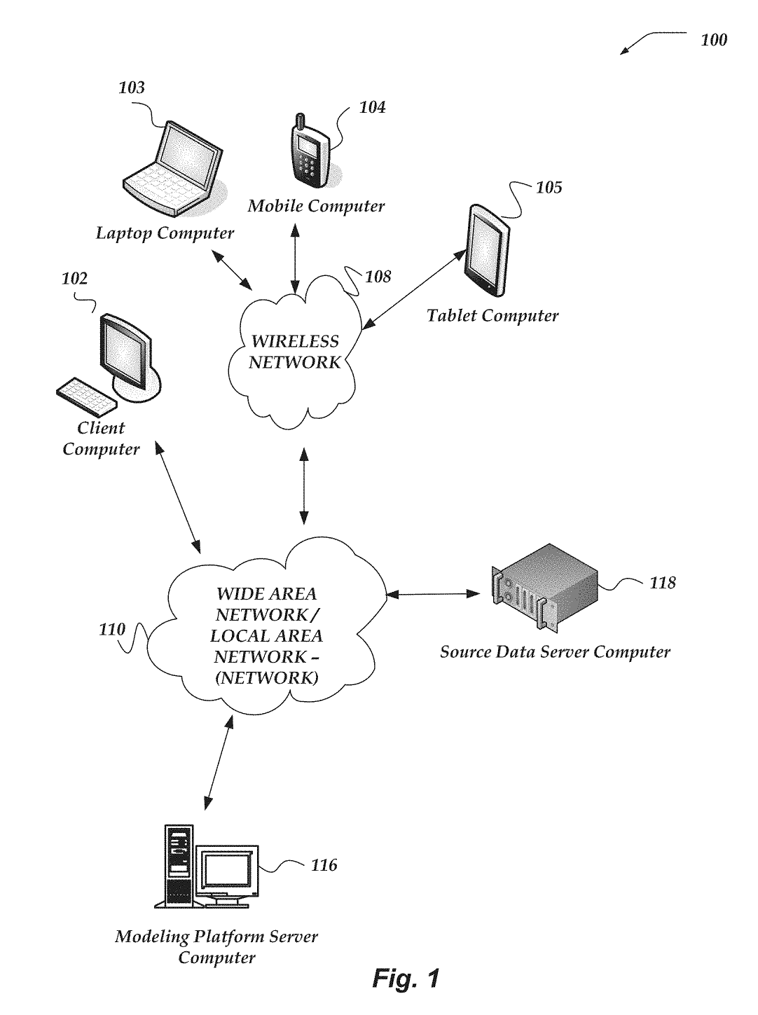

FIG. 1 shows components of one embodiment of an environment in which embodiments of the invention may be practiced. Not all the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, modeling platform server computer 116, one or more source data server computers 118, or the like.

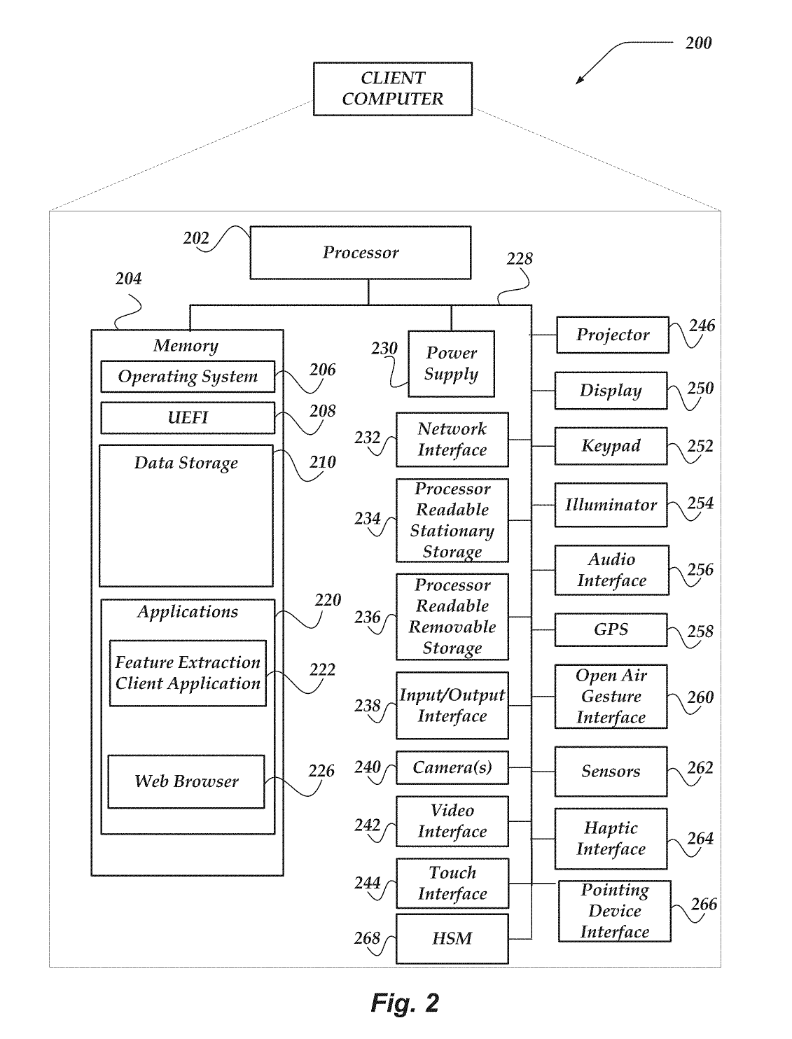

At least one embodiment of client computers 102-105 is described in more detail below in conjunction with FIG. 2. In one embodiment, at least some of client computers 102-105 may operate over one or more wired and/or wireless networks, such as networks 108, and/or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), JavaScript Object Notation (JSON), or the like, to display and send a message. In one embodiment, a user of the client computer may employ the browser application to perform various activities over a network (online). However, another application may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), universally unique identifiers (UUIDs), or other device identifiers. Such information may be provided in a network packet, or the like, sent between other client computers, modeling platform server computer 116, one or more source data server computers 118, or other computers.

Client computers 102-105 may further be configured to include a client application that enables an end-user to log into an end-user account that may be managed by another computer, such as modeling platform server computer 116, one or more source data server computers 118, or the like. Such an end-user account, in one non-limiting example, may be configured to enable the end-user to manage one or more online activities, including in one non-limiting example, project management, software development, system administration, data modeling, search activities, social networking activities, browse various websites, communicate with other users, or the like. Also, client computers may be arranged to enable users to display reports, interactive user-interfaces, and/or results provided by modeling platform server computer 116.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, modeling platform server computer 116, one or more source data server computers 118, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

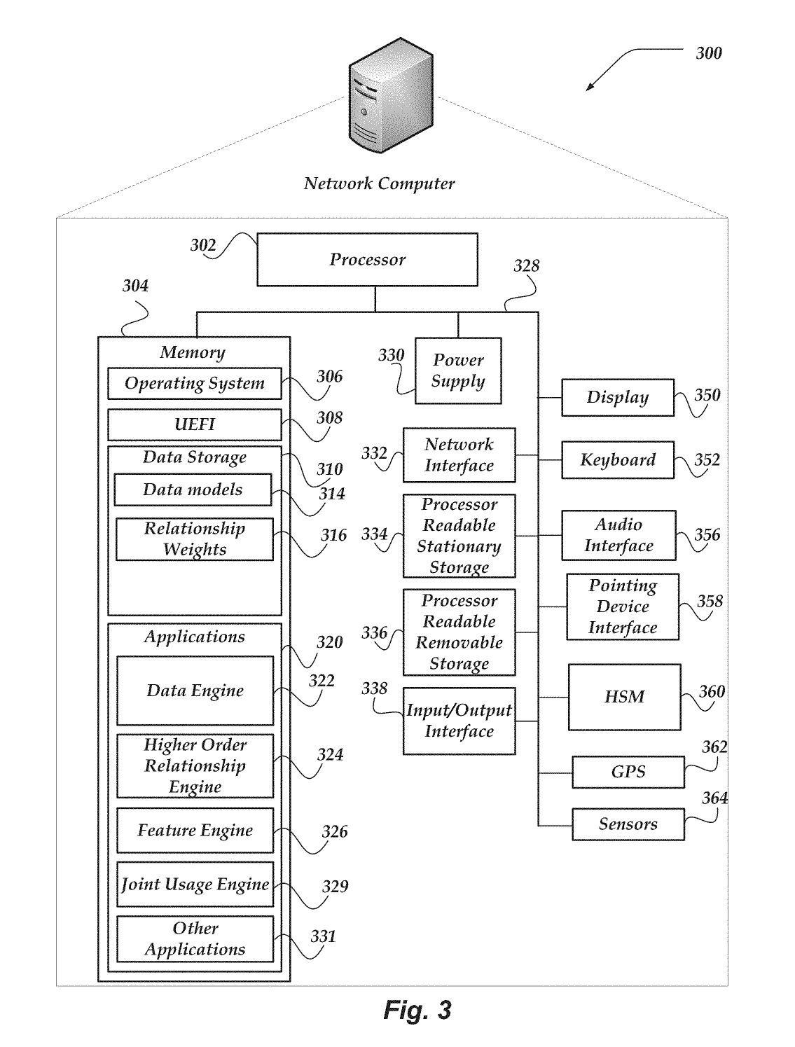

One embodiment of modeling platform server computer 116 is described in more detail below in conjunction with FIG. 3. Briefly, however, modeling platform server computer 116 includes virtually any network computer that is specialized to provide data modeling services as described herein.

Although FIG. 1 illustrates modeling platform server computer 116 as a single computer, the innovations and/or embodiments are not so limited. For example, one or more functions of modeling platform server computer 116, or the like, may be distributed across one or more distinct network computers. Moreover, modeling platform server computer 116 is not limited to a particular configuration such as the one shown in FIG. 1. Thus, in one embodiment, modeling platform server computer 116 may be implemented using a plurality of network computers. In other embodiments, server computers may be implemented using a plurality of network computers in a cluster architecture, a peer-to-peer architecture, or the like. Further, in at least one of the various embodiments, modeling platform server computer 116 may be implemented using one or more cloud instances in one or more cloud networks. Accordingly, these innovations and embodiments are not to be construed as being limited to a single environment, and other configurations, and architectures are also envisaged.

### Illustrative Client Computer

FIG. 2 shows one embodiment of client computer 200 that may include many more or less components than those shown. Client computer 200 may represent, for example, at least one embodiment of mobile computers or client computers shown in FIG. 1.

Client computer 200 may include one or more processors, such as processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope, accelerometer, or the like may be employed within client computer 200 to measuring and/or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, electronic paper, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing and/or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, and/or store keys pairs, or the like. In some embodiments, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, display screen glasses, remote speaker system, remote speaker and microphone system, and the like. Input/output interface 238 can utilize one or more technologies, such as Universal Serial Bus (USB), Infrared, WiFi, WiMax, Bluetooth™, Bluetooth Low Energy. or the like.

Haptic interface 264 may be arranged to provide tactile feedback to a user of the client computer. For example, the haptic interface 264 may be employed to vibrate client computer 200 in a particular way when another user of a computer is calling. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

In at least one of the various embodiments, client computer 200 may also include sensors 262 for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), light monitoring, audio monitoring, motion sensors, or the like. Sensors 262 may be one or more hardware sensors that collect and/or measure data that is external to client computer 200

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In at least one embodiment, however, client computer 200 may, through other components, provide other information that may be employed to determine a physical location of the client computer, including for example, a Media Access Control (MAC) address, IP address, and the like.

In at least one of the various embodiments, applications, such as web browser 226, or the like, may be arranged to employ geo-location information to select one or more localization features, such as, time zones, languages, currencies, calendar formatting, or the like. Localization features may be used in user-interfaces, reports, as well as internal processes and/or databases. In at least one of the various embodiments, geo-location information used for selecting localization information may be provided by GPS 258. Also, in some embodiments, geolocation information may include information provided using one or more geolocation protocols over the networks, such as, wireless network 108 and/or network 111.

Human interface components can be peripheral devices that are physically separate from client computer 200, allowing for remote input and/or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™, Bluetooth Low Energy, or the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that may be configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store Unified Extensible Firmware Interface (UEFI) 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™. The operating system may include, or interface with a Java and/or JavaScript virtual machine modules that enable control of hardware components and/or operating system operations via Java application programs or JavaScript programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of events, including being sent as part of a header during a communication, sent upon request, or the like. Data storage 210 may also be employed to store social networking information including address books, buddy lists, aliases, user profile information, user credentials, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, and/or otherwise process instructions and data. Applications 220 may include, for example, feature extraction client application 222. In at least one of the various embodiments, feature extraction client application 222 may be used to interact with a modeling platform, e.g. modeling platform server computer 116, to directly affect the computational knowledge graph, e.g. by performing user training or individual edge biasing. Feature extraction client 222 may also be used to perform administrative tasks, such as initiating a passive learning operation.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include one or more embedded logic hardware devices instead of one or more CPUs, such as, an Application Specific Integrated Circuits (ASICs), Field Programmable Gate Arrays (FPGAs), Programmable Array Logic (PAL), or the like, or combination thereof. The embedded logic hardware devices may directly execute embedded logic to perform actions. Also, in one or more embodiments (not shown in the figures), the client computer may include one or more hardware microcontrollers instead of one or more CPUs. In at least one embodiment, the microcontrollers be system-on-a-chips (SOCs) that may directly execute their own embedded logic to perform actions and access their own internal memory and their own external Input and Output Interfaces (e.g., hardware pins and/or wireless transceivers) to perform actions.

### Illustrative Network Computer

FIG. 3 shows one embodiment of network computer 300 that may be included in a system implementing one or more embodiments of the described innovations. Network computer 300 may include many more or less components than those shown in FIG. 3. However, the components shown are sufficient to disclose an illustrative embodiment for practicing these innovations. Network computer 300 may represent, for example, one embodiment of modeling platform server computer 116 of FIG. 1.

As shown in the figure, network computer 300 includes a processor 302 in communication with a memory 304 via a bus 328. Network computer 300 also includes a power supply 330, network interface 332, audio interface 356, global positioning systems (GPS) receiver 362, display 350, keyboard 352, input/output interface 338, processor-readable stationary storage device 334, and processor-readable removable storage device 336. Power supply 330 provides power to network computer 300. In some embodiments, processor 302 may be a multiprocessor system that includes one or more processors each having one or more processing/execution cores.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. Display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

GPS transceiver 362 can determine the physical coordinates of network computer 300 on the surface of the Earth, which typically outputs a location as latitude and longitude values. GPS transceiver 362 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 362 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, data engine 322, higher order relationship engine 324, feature engine 326, joint usage engine 329, or other applications 331 or the like, may be arranged to employ geo-location information to select one or more localization features, such as, time zones, languages, currencies, calendar formatting, or the like. Localization features may be used in data model meta-data, data model objects, machine learning, user-interfaces, reports, as well as internal processes and/or databases. In at least one of the various embodiments, geo-location information used for selecting localization information may be provided by GPS 362. Also, in some embodiments, geolocation information may include information provided using one or more geolocation protocols over the networks, such as, wireless network 108 or network 110.

Network computer 300 may also include sensors 364 for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), light monitoring, audio monitoring, motion sensors, or the like. Sensors 364 may be one or more hardware sensors that collect and/or measure data that is external to network computer 300

In at least one embodiment, however, network computer 300 may, through other components, provide other information that may be employed to determine a physical location of the client computer, including for example, a Media Access Control (MAC) address, IP address, and the like.

Human interface components can be physically separate from network computer 300, allowing for remote input and/or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

Memory 304 may include Random Access Memory (RAM), Read-Only Memory (ROM), and/or other types of non-transitory computer readable and/or writeable media. Memory 304 illustrates an example of computer-readable storage media (devices) for storage of information such as computer-readable instructions, data structures, program modules or other data. Memory 304 stores a unified extensible firmware interface (UEFI) 308 for controlling low-level operation of network computer 300. The memory also stores an operating system 306 for controlling the operation of network computer 300. It will be appreciated that this component may include a general-purpose operating system such as a version of UNIX, or Linux®, or a specialized operating system such as Microsoft Corporation's Windows® operating system, or the Apple Corporation's OSX® operating system. The operating system may include, or interface with a Java virtual machine module that enables control of hardware components and/or operating system operations via Java application programs. Likewise, other runtime environments may be included.

Memory 304 may further include one or more data storage 310, which can be utilized by network computer 300 to store, among other things, applications 320 and/or other data. For example, data storage 310 may also be employed to store information that describes various capabilities of network computer 300. The information may then be provided to another device or computer based on any of a variety of events, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by one or more processors, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, data models 314, relationship propagation weights 316, or the like.

Applications 320 may include computer executable instructions which, when executed by network computer 300, transmit, receive, and/or otherwise process messages (e.g., SMS, Multimedia Messaging Service (MMS), Instant Message (IM), email, and/or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include data engine 322, higher order relationship engine 324, feature engine 326, joint usage engine 329, other applications 331, or the like, that may perform actions further described below. In at least one of the various embodiments, one or more of the applications may be implemented as modules and/or components of another application. Further, in at least one of the various embodiments, applications may be implemented as operating system extensions, dynamic libraries, modules, plugins, Application Specific Integrated Circuits (ASICs), Field Programmable Gate Arrays (FPGAs), Programmable Array Logic (PALs), or the like, or combination thereof.

Furthermore, in at least one of the various embodiments, data engine 322, higher order relationship engine 324, feature engine 326, joint usage engine 329, or other applications 331 may be operative in a cloud-based computing environment. In at least one of the various embodiments, these engines, and others, that comprise the modeling platform that may be executing within virtual machines and/or virtual servers that may be managed in a cloud-based based computing environment. In at least one of the various embodiments, in this context applications including the engines may flow from one physical network computer within the cloud-based environment to another depending on performance and scaling considerations automatically managed by the cloud computing environment. Likewise, in at least one of the various embodiments, virtual machines and/or virtual servers dedicated to data engine 322, higher order relationship engine 324, feature engine 326, joint usage engine 329, and/or other applications 331 may be provisioned and de-commissioned automatically.

Further, in some embodiments, network computer 300 may also include hardware security module (HSM) 360 for providing additional tamper resistant safeguards for generating, storing and/or using security/cryptographic information such as, keys, digital certificates, passwords, passphrases, two-factor authentication information, or the like. In some embodiments, hardware security module may be employ to support one or more standard public key infrastructures (PKI), and may be employed to generate, manage, and/or store keys pairs, or the like. In some embodiments, HSM 360 may be arranged as a hardware card that may be installed in a network computer.

Additionally, in one or more embodiments (not shown in the figures), network computer 300 may include an one or more embedded logic hardware devices instead of one or more CPUs, such as, Application Specific Integrated Circuits (ASICs), Field Programmable Gate Arrays (FPGAs), Programmable Array Logic (PALs), or the like, or combination thereof. The one or more embedded logic hardware devices may directly execute its embedded logic to perform actions. Also, in one or more embodiments (not shown in the figures), the network computer may include one or more hardware microcontrollers instead of one or more CPUs. In at least one embodiment, the one or more microcontrollers may directly execute embedded logic to perform actions and access their own internal memory and their own external Input and Output Interfaces (e.g., hardware pins and/or wireless transceivers) to perform actions. E.g., they may be arranged as Systems On Chips (SOCs).

### Illustrative Logical System Architecture

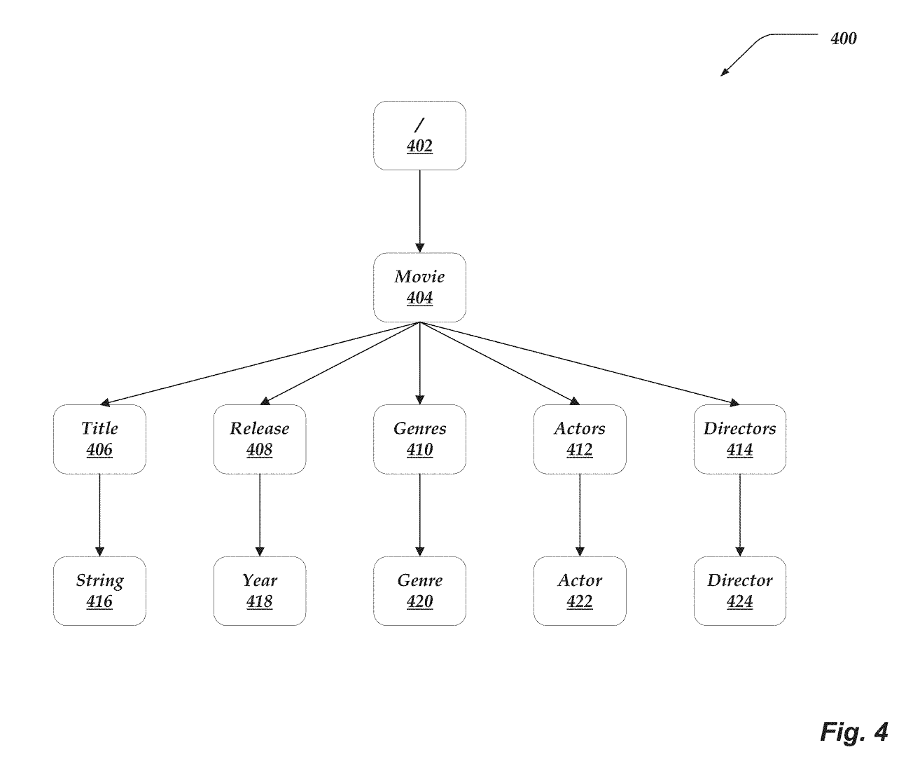

FIG. 4 shows a data model 400 in accordance with one or more of the various embodiments. In one embodiment, domain knowledge may be digitally represented in the form of reusable data models which capture concepts and the relationships between them. The models may be connected to form an intelligent, relationship driven, searchable and scalable semantic data model.

In one or more of the various embodiments, deriving a set of features based on a data model provides advantages over other forms of source data. For example, many machine learning systems accept flat tabular data as input. Others may de-normalize (flatten) data stored in a relational database before ingesting it. However, these flat data sources lose the rich layout and weighting of relationships defined by the data model, and as a result have less information available from which to select a concise yet effective set of features.

FIG. 4 depicts one example of a data model in the domain of movies. Each of nodes 406-414 in the data model represents a concept, such as “genres” or “directors”, while each edge represents a relationship between concepts. Data model also include instances of concepts, such as genre 420 and director 424. Specifically, FIG. 4 depicts a root node 402, a movie node 404, a title node 406, a release node 408, genres node 410, an actors node 412, a directors node 414, a string node 416, a year node 418, a genre node 420, an actor node 422, and a director node 424. In one embodiment, these nodes and the relationships between them may be determined by subject matter experts.

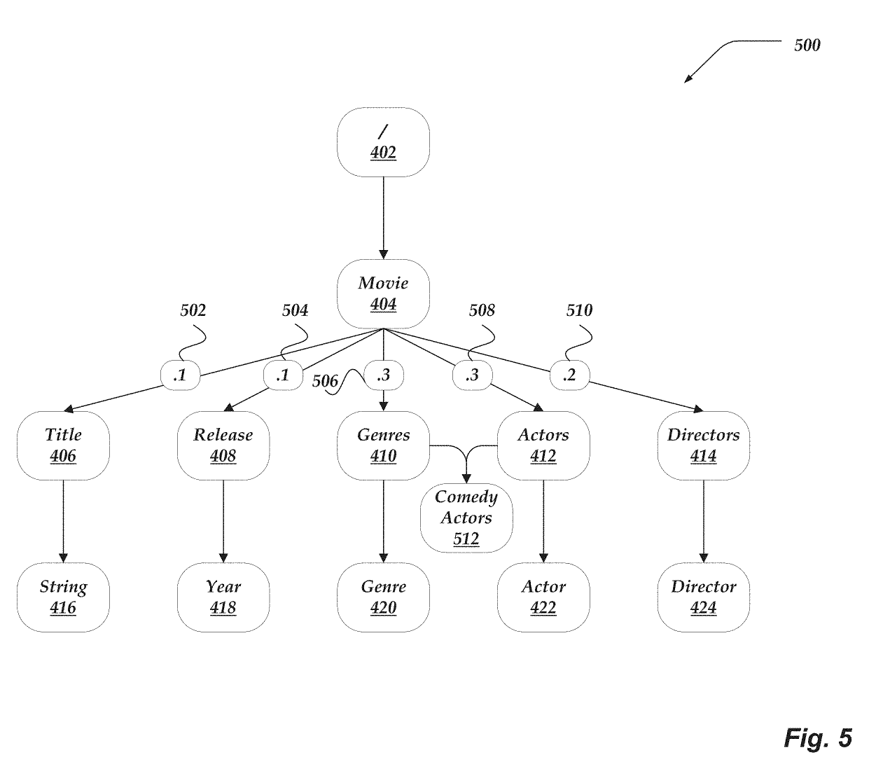

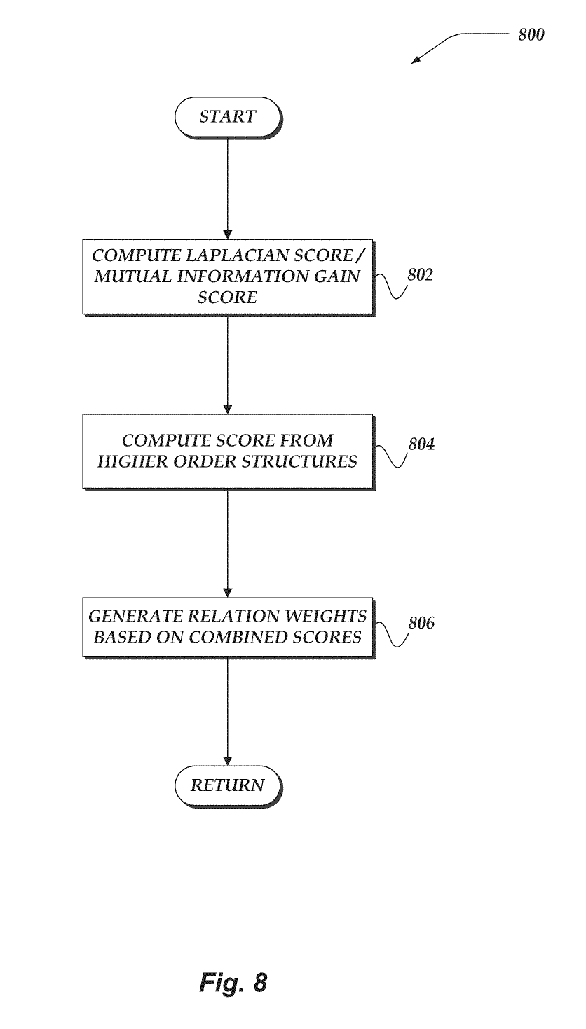

FIG. 5 shows a data model 500 with weighted edges (relations) in accordance with one or more of the various embodiments. Data model 500 includes the same concepts and relations as depicted in data model 400, with the addition of propagation weights 502 (0.1), 504 (0.1), 506 (0.3), 508 (0.3), and 510 (0.2). Data model 500 may depict a state after an initial setup, discussed below in conjunction with FIG. 8, has been performed. Additionally or alternatively, weights 502-510 may represent the state of data model 500 after one or more optional steps 704 (perform manual training), 706 (perform passive learning), and/or 708 (perform direct relationship biasing) have been performed.

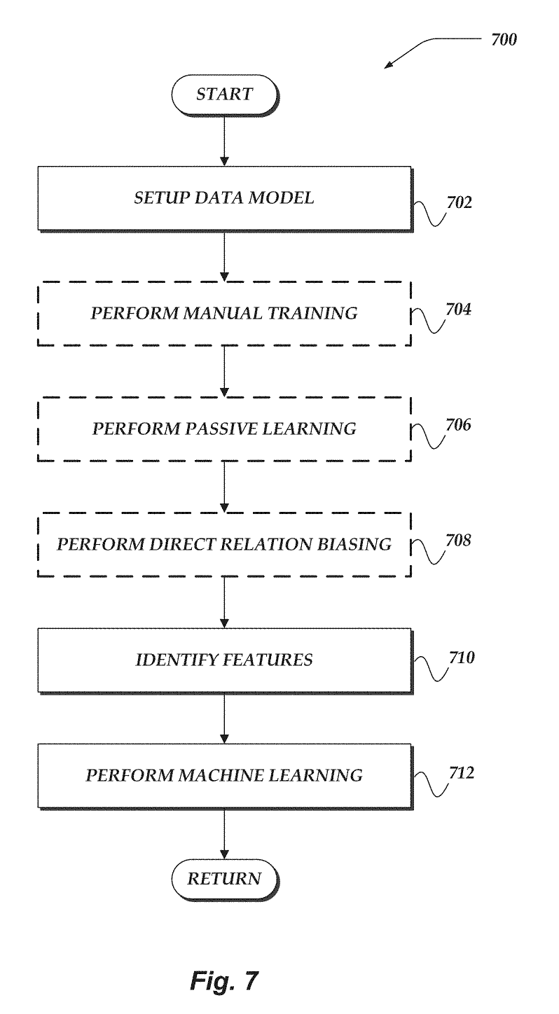

In one embodiment, propagation weights may be used to determine the importance of features, as discussed below in conjunction with step 712 of FIG. 7. Briefly, however, in one embodiment, a user provides an “impetus value” to one of the nodes of the data model. The impetus may propagated throughout the data model in proportion to the propagation weights of relations. For example, the propagation weight between the movie 404 and actors 412 (0.3) is greater than the propagation weight between movie 404 and release 408 (0.1). Thus, a greater amount of an impetus associated with movie 404 will flow to actors 412 of than release 408.

In one embodiment, propagation weights 502-510 may be initialized during a set up process. In one embodiment, a Laplacian score and/or a mutual information gain score may initially seed propagation weights, although either score could be used individually or in combination with other unsupervised algorithms that weigh connections in a knowledge graph.

Additionally or alternatively, a higher order structure score may be computed and integrated into the data model. One example of a higher order structure is an inferred/derived concept node defined in terms of two or more other concept nodes in the data model. For example, a node 512 called “comedy actor” may be added to the constitutional knowledge graph 500 by a domain expert, defined as actors who have appeared in movies of the comedy genre. This node may be created for many reasons, such as analyzing how many comedy actors cross over into other genres. Regardless of why it has been added, the fact that this concept relates the actor and genre concept nodes may add weight to the relationship between these concepts.

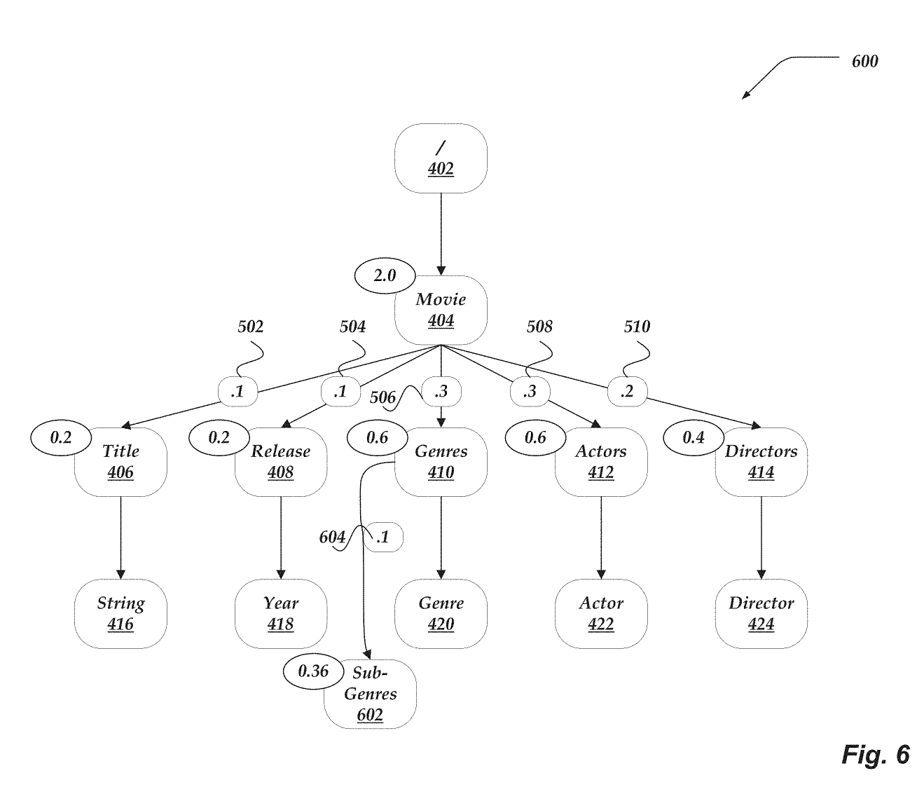

FIG. 6 shows data model 600 with an activation at a particular node that has spread to adjacent notes, in accordance with one or more of the various embodiments. Specifically, movie 404 has been given an activation impetus value of 2.0, which is spread along the weighted relations to yield a value of 0.2 at title 406 and release 408, a value of 0.6 and genres 410 and actors 412, and a value of 0.4 at directors 414. As discussed more below in conjunction with step 712 of FIG. 7, a user provided threshold value may be used to identify feature concepts, wherein feature concepts may be identified as concepts that have been allocated a portion of the impetus value greater than or equal to the received threshold. In this way, users may be enabled to extract larger (or smaller) numbers of feature concepts by increasing (decreasing) the impetus value or reducing (increasing) the threshold.

Graph 600 represents how feature concepts may be identified by how they spread out from a pivot concept based on propagation weights in a data model. This is in contrast to prior solutions that begin with a set of all possible features before winnowing them down to a final set of selected features. The innovations described herein improve upon prior solutions by reducing the tendency to include too many features in the final feature set. Accordingly, the identification of feature concepts reduces one or more computing resources required to train, or otherwise employ, the machine learning model.

### Generalized Operations

FIGS. 7-10 represent the generalized operations for graph activation based feature extraction in a data model in accordance with at least one of the various embodiments. In one or more of the various embodiments, processes 700, 800, 900, and 1000 described in conjunction with FIGS. 7-10 may be implemented by and/or executed on a single network computer, such as network computer 300 of FIG. 3. In other embodiments, these processes or portions thereof may be implemented by and/or executed on a plurality of network computers, such as network computer 300 of FIG. 3. However, embodiments are not so limited, and various combinations of network computers, client computers, virtual machines, or the like may be utilized. Further, one or more of the various embodiments, the processes described in conjunction with FIGS. 7-10 may be operative in machine-assisted feature extraction such as described in conjunction with FIGS. 4-6.

FIG. 7 illustrates an overview flowchart for process 700 for graph activation based feature extraction in a data model, in accordance with one or more of the various embodiments. After a start block, at block 702, in one or more of the various embodiments, a setup procedure may be performed to provide an data model that may include a data model. In one or more of the various embodiments, an initial set of edge weights for relations (hereinafter “propagation weights”) may be assigned to the edges in the data model.

A more detailed discussion of setting up a data model appears below in conjunction with FIG. 8. Briefly, however, initialization includes transforming a domain data model that defines concept nodes and relations between the concept nodes into an data model. The domain data model may be automatically created during the ingestion of one or more raw data sets. Further, in some embodiments, one or more ingestion rules may be defined or applied to raw data to identify one or more relations between concepts. In some embodiments, the automatic ingestion of raw data may be augmented by data scientists or domain experts.

Further, in some embodiments, the data model may be traversed and analyzed to provide a data model with some or all of the relation edges assigned a propagation weight value. In one embodiment, propagation weights in an data model may be determined in part based on the model structure itself, e.g. the geometry of the data model or the data model. In one or more of the various embodiments, various statistical or heuristic analysis may be performed on the data model to assign the propagation weights. In one or more of the various embodiments, weight assignment actions may be selected because they perform faster than conventional machine learning techniques.

For example, propagation weights may be assigned to relations based in part on a Laplacian score or a mutual information gain score, although any other feature importance metric that falls under the category of filter-metrics for unsupervised feature extraction can be used. The particular strategy for propagation weight assignment may vary depending on the data domain or the purpose or focus of the data model being used. Accordingly, in one or more of the various embodiments, one or more propagation weight assignment rules may be associated with particular data domains or applications.

In one or more of the various embodiments, propagation weights for a relation between two or more concepts may also be enhanced or modified in part based on the existence of higher order structures that reference the two or more concepts. In one embodiment, higher order structures may added to the data model by one or more automated processes, subject matter experts, derived or defined by the underlying data model, or the like. Accordingly, in some embodiments, concepts that do not exist as a ground concepts may be created or exposed from two or more ground concepts. In this way, the meaning of the derived concept need not matter—that a subject matter expert has associated the concept nodes is enough to enhance the corresponding propagation weight.

In one embodiment, the calculations performed to initialize data models may be independent of a particular machine learning methods that will ultimately be used, and are without reference to any machine learning categorization or machine learning model generation that may be performed on the data. This provides another benefit over existing techniques, which often identify features with a particular machine learning technique in mind, and therefore may not be generalizable to other machine learning problems.

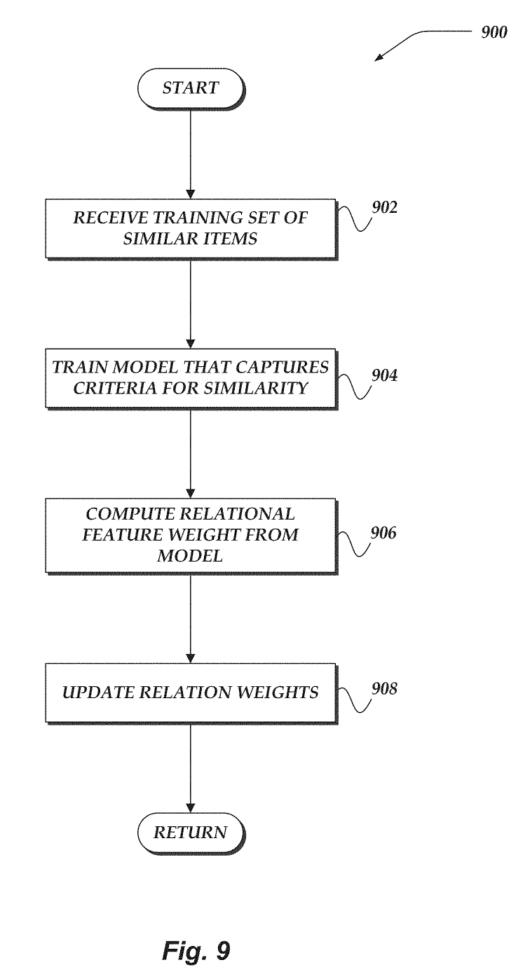

At block 704, optionally, in some embodiments, manual training may be performed. Manual training is discussed in more detail below in conjunction with FIG. 9. Briefly, however, in one or more of the various embodiments, manual training may include generating a similarity model. The similarity model will identify features that the model believes the trainer is using as the basis for deeming two nodes similar. In one embodiment, binary relations, e.g. has an actor won an award for best supporting actor, are a type of feature that a similarity model may consider. Once a similarity model has been created, feature engine 326 may query the similarity model to determine how important each binary relation is in determining similarity, and use that importance when weighting corresponding relations in the data model. Similar to leveraging derived/inferred concept, a trained similarity model is not used to identify similar pieces of raw data, but rather is queried for how it makes that decision (i.e. how important are the “binary relation features” in determining similarity), the intuition being that whatever is important when identifying similar pieces of raw data may also be important when extracting features.

At block 706, optionally, passive learning may be performed. In one embodiment, joint usage engine 329 may be arranged to analyze end-user usage patterns as another factor in determining weights of relations. Performing passive learning 706 is based on an insight that the weight of a connection between two nodes in an data model should be increased or decreased in proportion their co-activation. For example, two or more concepts can be analyzed to determine how often they appear in queries, rules, or the like. One or more rules may be defined to increase the associated propagation weight based on how often the two or more concepts are used contemporaneously in the same (or related) queries, rules, or the like.

At block 708, optionally, in one or more of the various embodiments, direct relation biasing may be performed. In one embodiment, a user may be unsatisfied with a particular propagation weight, even after performing manual training and or passive learning. In these cases, the user may manually modify weight scores for one or more relations in the data model. Users may manually bias relations for various reasons, including experimentation, domain knowledge that is not reflected in the domain data model, or the like.

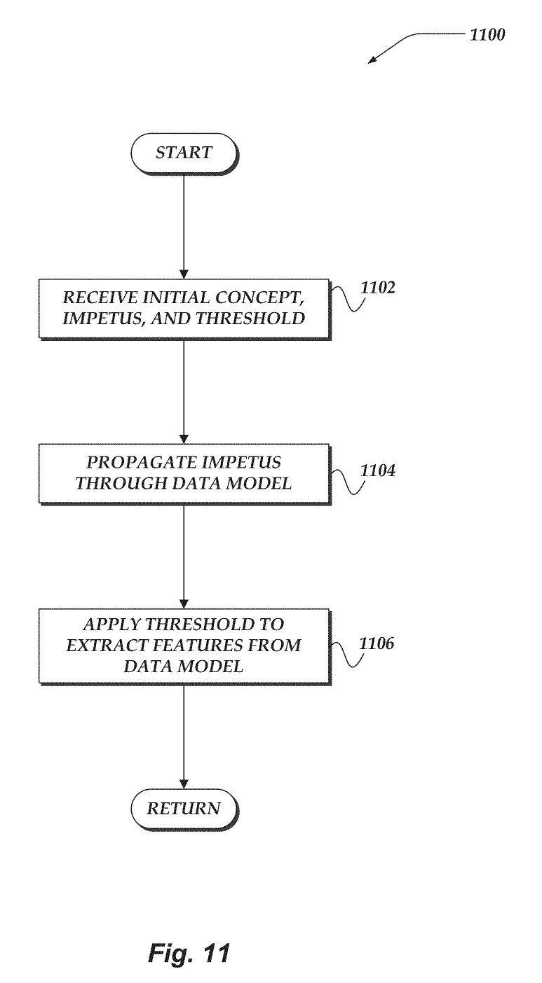

At block 710, a set of features may be identified from the data model. Feature extraction is discussed in more detail below in conjunction with FIG. 11. Briefly, however, a subset of the data model may be determined. An initial impetus value may be received and applied to a selected pivot concept. Then, recursively, portions of the impetus value may be distributed to unvisited adjacent concept nodes in proportion to the propagation weight associated with the relation with that concept node. This recursive traversal continues until the portion of the impetus value that would be assigned to a concept node is below a defined threshold. At this point, the strength of the relations or concept nodes may be considered too attenuated to be an effective feature as related to the pivot concept. The resulting set of concept nodes having values above the threshold may then identified as feature concepts.

In one or more of the various embodiments, cutoff thresholds may be defined using one or more allocation rules, configuration information, user input, or the like, or combination thereof. Cutoff thresholds may be assigned different values depending on the concept type of a node or its adjacent nodes. Further, in one or more of the various embodiments, cutoff thresholds may be dynamically determined based on local relationships. In one or more of the various embodiments, back tracking may be used to fixup or modify activation scores (e.g., the portion of the impetus value allocated to a visited concept) as the data model is traversed. For example, in some embodiments, an allocation rule may be arranged to clamp neighboring activation scores to a defined value upon one or more conditions being. For example, in some embodiments, an allocation rule may be defined to clamp two or more activation scores to zero if a third low score is determined. Likewise, in one or more of the various embodiments, allocation rules may include conditions that evaluate a rate of change of activation scores, or the like.

At block 712, one or more machine learning activities may be performed using the identified feature concepts. In one embodiment machine learning tasks such as classification, filtering, computer vision, or the like are contemplated. In one or more of the various embodiments, feature concepts identified from the data model may be used to identify features that may be used for training one or more machine learning models. Selecting feature concepts using the data model may reduce one or more computing resources, such as, the learning time or learning effort that may be required by one or more machine learning systems. Otherwise, in some embodiments, the machine learning system may use more features than necessary, not enough features, or the “wrong” features when generating machine learning models.

Another, benefit of the innovations described herein is the ability to extract features without regard to which machine learning algorithm will consume the features. For example, whether the identified features will be used for classification, pattern recognition, or the like, is immaterial.

Next, control may be returned to a calling process.

FIG. 8 illustrates a flowchart for process 800 for assigning initial propagation weights to relations in an data model, in accordance with one or more of the various embodiments. After a start block, at block 802, in one or more of the various embodiments, data engine 322 computes a propagation weights based on the data model structure itself, e.g. the geometry of the data model. Also, in one or more of the various embodiments, various statistical or heuristic analysis operations may be performed on the data model to assign the propagation weights.

In some embodiments, a Laplacian score based on the geometry of the concept nodes and the relations between them may be computed. In one embodiment, a Laplacian score may be calculated using well-known techniques based on a k-nearest neighbor graph such that the basic idea is to evaluate features according to their locality preserving power. Additionally or alternatively, a mutual information gain score may be computed from the data model. Additionally or alternatively, data engine 322 computes a mutual information gain score based on the layout of the concept nodes in the relations between them.

In one embodiment, propagation weights may be determined in part based on the model structure itself, e.g. the geometry of the data model. In one or more of the various embodiments, various statistical or heuristic analysis operations may be performed on the data model to assign the propagation weights. For example, weights may be assigned to relations based in part on a Laplacian score or a mutual information gain score, although any other feature importance metric that falls under the category of filter-metrics for unsupervised feature extraction can be used. The particular strategy for weight assignment may vary depending on the data domain or the purpose or focus of the data model being used. Accordingly, in one or more of the various embodiments, one or more weight assignment rules may be associated with particular data domains or application focus.

At block 804, in one or more of the various embodiments, higher order relationship engine 324 computes a score based on appearances of relations or references to relations occurring in higher order structures, such as derived/inferred concepts. For example, in one embodiment, concepts in an data model may include ground concepts such as genres and actors that are represented directly in the domain data model (e.g., without any additional processing). However, data models may represent higher order structures such as derived/inferred concepts. In one embodiment, an inferred concept includes an inference rule defined in terms of two or more ground concepts.

One example of a higher-order structure is the inferred concept of a comedy actor depicted above in FIG. 5. A comedy actor is not a ground concept—there is no domain data object that directly corresponds to comedy actor. However by defining a comedy actor as an actor who has participated in a comedy genre, a combination of ground concepts may be used to create an inferred concept.

In one or more of the various embodiments, higher order relationship engine 324 may be arranged to analyze an data model to determine the relations used to define one or more higher order structures. Accordingly, some relations may stand out because they may be being used to define one or more higher-order structure(s), such as the relations between actors and genre in inferred concept 512. Whereas, in this example, other relations, such as actors 412 and release date 408, will not. Additionally or alternatively, an analysis of higher order structures may be performed to determine which relations occur in comparatively large numbers of inference rules. For example, if in the domain of movies depicted in FIGS. 4-6 there are thirty inference rules, and a relation between movie and genre appears in twenty-seven of them, the relation between movie and genre may be assigned a higher propagation weight than a relation that appears in only five of the inference rules.

At block 806, in one or more of the various embodiments, scores from blocks 802 and 804 are combined to provide a weight score for one or more relations of the data model. In one embodiment, a higher score may correlate with a larger propagation weight. As discussed above, the weight score represents the proportion of the activation impetus value that is allocated from one related concept node to an adjacent concept node. In one or more of the various embodiments, one or more allocation rules or configuration information may be used to define the specific propagation weight modification actions. They may include modifying weight scores by an absolute amount, a percentage, a multiplier, or the like. Next, control may be may be returned to a calling process.

FIG. 9 illustrates a flowchart process 900 for optional user training using a similarity model in accordance with one or more of the various embodiments. After a start block, at block 902, in one or more of the various embodiments, one or more training sets, each comprising two or more instances of a concept deemed similar by a user, is received by similarity engine that may be separate or part of data engine 322. For example, a user may deem that “The Godfather” and “Goodfellas” are similar movies.

At block 904, for each training set, a similarity engine learns a model that determines one or more criteria for similarly. In one embodiment, the similarity engine identifies features that are the basis for the similarity. Continuing the example, “The Godfather” and “Goodfellas” may share a theme and some number of actors. Given a large enough number of training sets (e.g. supplying additional pairs of movies deemed by a user to be similar), a similarlity engine may determine that, based on the training sets it has processed, the user(s) supplying those training sets believe movies to be similar primarily based on having lead actors in common. In order to make these determinations, the similarity model must assign an importance to each feature.

However, that a relation exists between two concepts can be considered a feature—a “relation feature”. A relation feature may be thought of as a binary feature with a true or false answer depending on whether some input data has the relation. For example, whether or not “The Godfather” has won an award is a binary feature.

At block 906, once a similarity model has been trained, the model can be queried with a “relation feature” to determine how significant that relation is to the similarity model. In one embodiment, this query is performed for each relation in the data model, such that a weight for each features may be updated. In one embodiment, as with “higher order structures”, that the “relation feature” exists in a similarity model is enough to give the corresponding relation greater weight. Additionally or alternatively, the significance the similarity model ascribes to a “relation feature” correlates with an amount by which the weight of the corresponding relation is modified.

At block 908, propagation weights are updated based on the existence of a “relation feature” in the similarity model, or based on a significance of the “relation feature” in the similarity model. Next, control may be returned to a calling process.

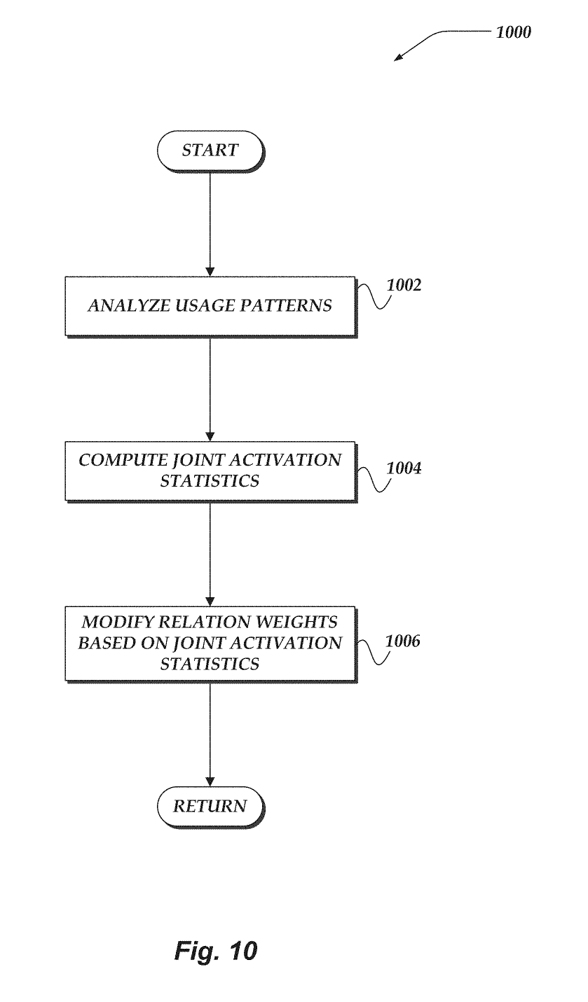

FIG. 10 illustrates a flowchart of process 1000 for passive learning based on joint activation statistics, in accordance with one or more of the various embodiments. After a start block, at block 1002, in one or more of the various embodiments, user usage statistics may be catalogued and analyzed. In one embodiment, user usage statistics may be based on one or more metrics associated with end-user queries submitted to the data model, data model, or the like. Also, in some embodiments, the number of rules executed while processing those queries. These queries may be submitted for the purpose of feature extraction, but they may also be submitted for any other use of the data model. In one embodiment, usage patterns may be analyzed on a periodic basis, e.g. hourly, weekly, monthly, or the like, although any frequency, or even a continuous application, is similarly contemplated.

At block 1004, in one or more of the various embodiments, joint activation statistics may be computed from the analyzed usage patterns. In one embodiment, an activation may be considered a joint activation if a query of the data model or a rule executed on the data model traverses, inspects, modifies, or otherwise interacts with two or more concept nodes. Accordingly, if two or more concept nodes are interacted with in this way, an association between them is created that may be used to inform propagation weights. For example, in some embodiments, a rule or configuration information may be defined to clamp relation scores between jointly activated nodes to the same value. In other embodiments, a rule may be arranged to identify relations that appears in two or more joint activation sets, increasing the score of the common relations and decreasing the scores of the relations not common to the two or more joint activation sets.

At block 1006, in one or more of the various embodiments, propagation weights may be modified based on the joint activation statistics. In one embodiment, propagation weights may be increased in proportion to the amount of joint activation between two concept nodes. However, propagation weights may be both increased and decreased, in proportion or as an absolute value, or the like. Accordingly, in some embodiments, one or more rules or configuration information may be defined that define actions, conditions, or constraints for modifying propagation weights.

Next, control may be returned to a calling process.

FIG. 11 illustrates a flowchart 1100 for utilizing weights to perform a feature concept identification. After a start block, at block At block 1104, in one or more of the various embodiments, the impetus value is propagated through the data model. In one embodiment, the impetus value is seeded at an initial pivot concept. For example, in FIG. 5, the impetus value of 2.0 is seeded at concept node 404 (Movie) making it the pivot concept. From this pivot concept, the portions of the impetus value are recursively allocated to adjacent non-visited nodes based on the propagation weights association with the relations of those nodes. For example, in FIG. 5, the impetus value of 2.0 is allocated to concept node 406 (Title) via a propagation weight 502 of 0.1. In one embodiment, the impetus is multiplied by the corresponding propagation weight to compute the value of the destination node. Continuing the example, an impetus value of 2.0 multiplied by a propagation weight of 0.1 yields a value of 0.2 allocated to concept node 406 (Title). Similar calculations are used to allocation values of 0.2, 0.6, 0.6, 0.4, and 0.4 to concept nodes 408-414, respectively.

This allocation process may be applied recursively. For example, concept node 410 (Genres) may have a relation with concept node 602 (Sub-genres), and a propagation weight 604 of 0.6. In this case, the value assigned to concept node 602 is 0.36.

In one embodiment, a value is only assigned to a concept node if it is above the received threshold. In this way, computational resources are conserved by not traversing the entire data model.

At block 1104, in one or more of the various embodiments, a threshold is applied to identify feature concepts in the data model. In on embodiment, the data model is traversed, and any concept nodes associated with a value greater than the threshold may be identified as feature concepts.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. These program instructions may be stored on some type of machine readable storage media, such as processor readable non-transitive storage media, or the like. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

1. A method for managing data using one or more processors, included in one or more network computers, to execute a modeling platform server that performs actions, comprising:
instantiating a data engine that performs actions, including:
providing a data model that includes a plurality of concepts and a plurality of relations between the concepts, wherein each concept is a node in the data model and each relation is an edge in the data model; and
associating a propagation weight with each relation based on one or more characteristics of the plurality of concepts, wherein the propagation weight is based on one or more heuristics that are determined prior to training of a machine learning model; and
instantiating a feature engine that performs actions, including:
associating an initial impetus value with a pivot concept, wherein a query is employed to select one of the plurality of concepts as the pivot concept;
employing the pivot concept as a start point to recursively traverse the data model;
allocating a portion of the impetus value to one or more concepts that are on a direct path of the traversal based on the propagation weight associated with each relation of the one or more concepts; and
identifying one or more of the plurality concepts as a feature concept based on a value of a portion of the impetus value that exceeds a threshold, wherein one or more of the feature concepts or the data model are visually presented in a display to a user, and wherein internal processes, databases, and elements of the visual presentation are modified based on geo-location information of the user provided by a global positioning system (GPS) device, and wherein the modified elements include one or more of a time zone, language, currency, or calendar format; and
instantiating a machine learning engine to employ the one or more feature concepts to train the machine learning model, wherein the use of the one or more feature concepts reduces one or more computing resources required to train the machine learning model.

2. The method of claim 1, wherein associating the propagation weight with each relation, further comprises, basing the propagation weight on one or more filter metrics for unsupervised feature extraction.

3. The method of claim 1, wherein associating the propagation weight with each relation, further comprises, basing the propagation weight on one or more of a laplacian score or a mutual information gain score that is associated with two or more concepts.

4. The method of claim 1, wherein the feature engine performs further actions, comprising, updating one or more propagation weights based on joint usage statistics captured from a user interacting with the data model, wherein one or more propagation weights in the data model are increased when two or more concepts having a relation are interacted with by the user.

5. The method of claim 1, wherein allocating the portion of the impetus value to the one or more concepts, further comprises, omitting one or more concepts from the allocation when the allocated portion of the impetus value is less than the threshold value.

6. The method of claim 1, wherein the feature engine performs further actions, comprising, increasing the portion of the impetus value associated with one or more of the plurality of concepts based on a number of times the one or more concepts were previously identified as the feature concept.

7. A system for managing data, comprising:
a network computer, comprising:
a transceiver that communicates over the network;
a memory that stores at least instructions; and
one or more processor devices that execute instructions that perform actions, including:
instantiating a data engine that performs actions, including:
providing a data model that includes a plurality of concepts and a plurality of relations between the concepts, wherein each concept is a node in the data model and each relation is an edge in the data model; and
associating a propagation weight with each relation based on one or more characteristics of the plurality of concepts, wherein the propagation weight is based on one or more heuristics that are determined prior to training of a machine learning model; and
instantiating a feature engine that performs actions, including:
associating an initial impetus value with a pivot concept, wherein a query is employed to select one of the plurality of concepts as the pivot concept;
employing the pivot concept as a start point to recursively traverse the data model;
allocating a portion of the impetus value to one or more concepts that are on a direct path of the traversal based on the propagation weight associated with each relation of the one or more concepts; and
identifying one or more of the plurality concepts as a feature concept based on a value of a portion of the impetus value that exceeds a threshold, wherein one or more of the feature concepts or the data model are visually presented in a display to a user, and wherein internal processes, databases, and elements of the visual presentation are modified based on geo-location information of the user provided by a global positioning system (GPS) device, and wherein the modified elements include one or more of a time zone, language, currency, or calendar format; and
instantiating a machine learning engine to employ the one or more feature concepts to train the machine learning model, wherein the use of the one or more feature concepts reduces one or more computing resources required to train the machine learning model; and
a client computer, comprising:
a client computer transceiver that communicates over the network;
a client computer memory that stores at least instructions; and
one or more processor devices that execute instructions that perform actions, including:
displaying one or more of the data model or one or more featured concepts on the display of the client computer.

8. The system of claim 7, wherein associating the propagation weight with each relation, further comprises, basing the propagation weight on one or more filter metrics for unsupervised feature extraction.

9. The system of claim 7, wherein associating the propagation weight with each relation, further comprises, basing the propagation weight on one or more of a laplacian score or a mutual information gain score that is associated with two or more concepts.

10. The system of claim 7, wherein the feature engine performs further actions, comprising, updating one or more propagation weights based on joint usage statistics captured from a user interacting with the data model, wherein one or more propagation weights in the data model are increased when two or more concepts having a relation are interacted with by the user.

11. The system of claim 7, wherein allocating the portion of the impetus value to the one or more concepts, further comprises, omitting one or more concepts from the allocation when the allocated portion of the impetus value is less than the threshold value.

12. The system of claim 7, wherein the feature engine performs further actions, comprising, increasing the portion of the impetus value associated with one or more of the plurality of concepts based on a number of times the one or more concepts were previously identified as the feature concept.

13. A processor readable non-transitory storage media that includes instructions for managing data, wherein execution of the instructions by one or more hardware processors performs actions, comprising:
instantiating a data engine that performs actions, including:
providing a data model that includes a plurality of concepts and a plurality of relations between the concepts, wherein each concept is a node in the data model and each relation is an edge in the data model; and
associating a propagation weight with each relation based on one or more characteristics of the plurality of concepts, wherein the propagation weight is based on one or more heuristics that are determined prior to training of a machine learning model; and
instantiating a feature engine that performs actions, including:
associating an initial impetus value with a pivot concept, wherein a query is employed to select one of the plurality of concepts as the pivot concept;
employing the pivot concept as a start point to recursively traverse the data model;
allocating a portion of the impetus value to one or more concepts that are on a direct path of the traversal based on the propagation weight associated with each relation of the one or more concepts; and
identifying one or more of the plurality concepts as a feature concept based on a value of a portion of the impetus value that exceeds a threshold, wherein one or more of the feature concepts or the data model are visually presented in a display to a user, and wherein internal processes, databases, and elements of the visual presentation are modified based on geo-location information of the user provided by a global positioning system (GPS) device, and wherein the modified elements include one or more of a time zone, language, currency, or calendar format; and
instantiating a machine learning engine to employ the one or more feature concepts to train the machine learning model, wherein the use of the one or more feature concepts reduces one or more computing resources required to train the machine learning model.

14. The media of claim 13, wherein associating the propagation weight with each relation, further comprises, basing the propagation weight on one or more filter metrics for unsupervised feature extraction.

15. The media of claim 13, wherein associating the propagation weight with each relation, further comprises, basing the propagation weight on one or more of a laplacian score or a mutual information gain score that is associated with two or more concepts.

16. The media of claim 13, wherein the feature engine performs further actions, comprising, updating one or more propagation weights based on joint usage statistics captured from a user interacting with the data model, wherein one or more propagation weights in the data model are increased when two or more concepts having a relation are interacted with by the user.

17. The media of claim 13, wherein allocating the portion of the impetus value to the one or more concepts, further comprises, omitting one or more concepts from the allocation when the allocated portion of the impetus value is less than the threshold value.

18. The media of claim 13, wherein the feature engine performs further actions, comprising, increasing the portion of the impetus value associated with one or more of the plurality of concepts based on a number of times the one or more concepts were previously identified as the feature concept.

19. A network computer for managing data, comprising:
a transceiver that communicates over the network;
a memory that stores at least instructions; and
one or more processor devices that execute instructions that perform actions, including:
instantiating a data engine that performs actions, including:
providing a data model that includes a plurality of concepts and a plurality of relations between the concepts, wherein each concept is a node in the data model and each relation is an edge in the data model; and
associating a propagation weight with each relation based on one or more characteristics of the plurality of concepts, wherein the propagation weight is based on one or more heuristics that are determined prior to training of a machine learning model; and
instantiating a feature engine that performs actions, including:
associating an initial impetus value with a pivot concept, wherein a query is employed to select one of the plurality of concepts as the pivot concept;
employing the pivot concept as a start point to recursively traverse the data model;
allocating a portion of the impetus value to one or more concepts that are on a direct path of the traversal based on the propagation weight associated with each relation of the one or more concepts; and
identifying one or more of the plurality concepts as a feature concept based on a value of a portion of the impetus value that exceeds a threshold, wherein one or more of the feature concepts or the data model are visually presented in a display to a user, and w wherein internal processes, databases, and elements of the visual presentation are modified based on geo-location information of the user provided by a global positioning system (GPS) device, and wherein the modified elements include one or more of a time zone, language, currency, or calendar format; and
instantiating a machine learning engine to employ the one or more feature concepts to train the machine learning model, wherein the use of the one or more feature concepts reduces one or more computing resources required to train the machine learning model.

20. The network computer of claim 19, wherein associating the propagation weight with each relation, further comprises, basing the propagation weight on one or more filter metrics for unsupervised feature extraction.

21. The network computer of claim 19, wherein associating the propagation weight with each relation, further comprises, basing the propagation weight on one or more of a laplacian score or a mutual information gain score that is associated with two or more concepts.

22. The network computer of claim 19, wherein the feature engine performs further actions, comprising, updating one or more propagation weights based on joint usage statistics captured from a user interacting with the data model, wherein one or more propagation weights in the data model are increased when two or more concepts having a relation are interacted with by the user.

23. The network computer of claim 19, wherein allocating the portion of the impetus value to the one or more concepts, further comprises, omitting one or more concepts from the allocation when the allocated portion of the impetus value is less than the threshold value.

24. The network computer of claim 19, wherein the feature engine performs further actions, comprising, increasing the portion of the impetus value associated with one or more of the plurality of concepts based on a number of times the one or more concepts were previously identified as the feature concept.
